(19) United States
(12) Patent Application Publication
(10) Pub. No.: US 2005/0240765 A1
(43) Pub. Date: Oct. 27, 2005

(54) Method and apparatus for authorizing access to grid resources

(75) Inventors: Denise Marie Genty, Austin, TX (US); Shawn Patrick Mullen, Buda, TX (US); Ernest B. Segura, Cedar Park, TX (US); James Stanley Tesauro, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/829,831

(22) Filed: Apr. 22, 2004

(51) Int. Cl. H04L 9/00

(52) U.S. Cl. 713/175

(57) ABSTRACT

A method, apparatus, and computer instructions for authorizing a user to access resources on a data processing system. A request to access resources on the data processing system is received. This request includes a certificate for use in authenticating the user making the request. An authentication process is performed using the certificate. If the user is authenticated, a determination is made as to whether an authorizing agent is specified in the certificate. A mapping for the user is requested from the authorizing agent, if the authorizing agent is specified in the certificate. The user is mapped to a local user on the data processing system using the mapping, in response to receiving the mapping for the user, wherein the user accesses resources on the data processing system as the local user. If an authorizing agent is not specified, the user is denied access to the resources.

### CROSS REFERENCE TO RELATED APPLICATIONS

The present invention is related to an application entitled “Method and Apparatus for Detecting Grid Intrusions”, Ser. No. ______, attorney docket no. AUS920040203US1, filed even date hereof, assigned to the same assignee, and incorporated herein by reference.

### BACKGROUND OF THE INVENTION

1. Technical Field

The present invention relates generally to an improved data processing system and in particular to an improved method and apparatus for accessing resources on a network. Still more particularly, the present invention relates to a method, apparatus, and computer instructions for authorizing a user to access resources or a network.

2. Description of Related Art

Network data processing systems are commonly used in all aspects of business and research. These networks are used for communicating data and ideas, as well as, providing a repository to store information. In many cases, the different nodes making up a network data processing system may be employed to process information. Individual nodes may have different tasks to perform. Additionally, it is becoming more common to have the different nodes work towards solving a common problem, such as a complex calculation. A set of nodes participating in a resource sharing scheme is also referred to as a “grid” or “grid network”. For example, nodes in a grid network may share processing resources to perform a complex computation, such as deciphering keys.

The nodes in a grid network may be contained within a network data processing system, such as a local area network (LAN) or a wide area network (WAN). These nodes also may be located in different geographically diverse locations. For example, different computers connected to the Internet may provide processing resources to a grid network. By applying the use of thousands of individual computers, large problems can be solved quickly. Grids are used in many areas, such as cancer research, physics, and geosciences.

The setup and management of grids are facilitated through the use of software, such as that provided by the Globus Toolkit and the IBM Grid Toolkit. The Globus Toolkit is an open source toolkit used in building grids. This toolkit includes software services and libraries for resource monitoring, discovery, and management, plus security and file management. The toolkit was developed by the Globus Alliance, which is based at Argonne National Laboratory, the University of Southern California's Information Sciences Institute, the University of Chicago, the University of Edinburgh, and the Swedish Center for Parallel Computers. The IBM Grid Toolkit is available from International Business Machines Systems, Inc. (IBM) for use with its systems.

Authorization of users to access different grid resources is currently handled by having a user requesting access or use of a grid resource. A grid resource is a server or service that is provided for distributed computing. A user requesting access to grid resources is provided access by mapping the user to a local user. The local user has privileges to allow for use of grid resources to perform a computing task. A grid map file is employed by the Globus Toolkit and the IBM Grid Toolkit to provide mapping of a user to local identities. The file is a N to 1 mapping of grid identities to local user identities. Currently, every grid resource must have a grid map file for the authorization process. This grid map file lists the identity of every grid user that is authorized to access the resource.

As a result, if an organization creates a grid of 500 data processing systems, every data processing system would need to have a grid map file to list an Internet or intranet name to a local user name. Every time a user joins or leaves this organization, every grid map file on every data processing system would need to be updated. This type of updating can be tedious, especially when some grids contain thousands of data processing systems.

Therefore, it would be advantageous to have an improved method, apparatus, and computer instructions for authorizing users to access grid resources.

### SUMMARY OF THE INVENTION

The present invention provides a method, apparatus, and computer instructions for authorizing a user to access resources on a data processing system. A request to access resources on the data processing system is received. This request includes a certificate for use in authenticating the user making the request. An authentication process is performed using the certificate. If the user is authenticated, a determination is made as to whether an authorizing agent is specified in the certificate. A mapping for the user is requested from the authorizing agent, if the authorizing agent is specified in the certificate. The user is mapped to a local user on the data processing system using the mapping, in response to receiving the mapping for the user, wherein the user accesses resources on the data processing system as the local user. If an authorizing agent is not specified, the user is denied access to the resources.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in distributing logical units in a network data processing system in accordance with a preferred embodiment of the present invention;

FIG. 5 is a diagram illustrating components used in authorizing access to grid resources in accordance with a preferred embodiment of the present invention;

FIG. 6 is a diagram illustrating a certificate for authorizing a user to access a grid resource in accordance with a preferred embodiment of the present invention;

FIG. 7 is a flowchart of a process for generating a certificate for a user in accordance with a preferred embodiment of the present invention; and

FIG. 8 is a flowchart of a process for authorizing a user to access a grid resource in accordance with a preferred embodiment of the present invention.

### DETAILED DESCRIPTION OF THE PREFERRED EMBODIMENT

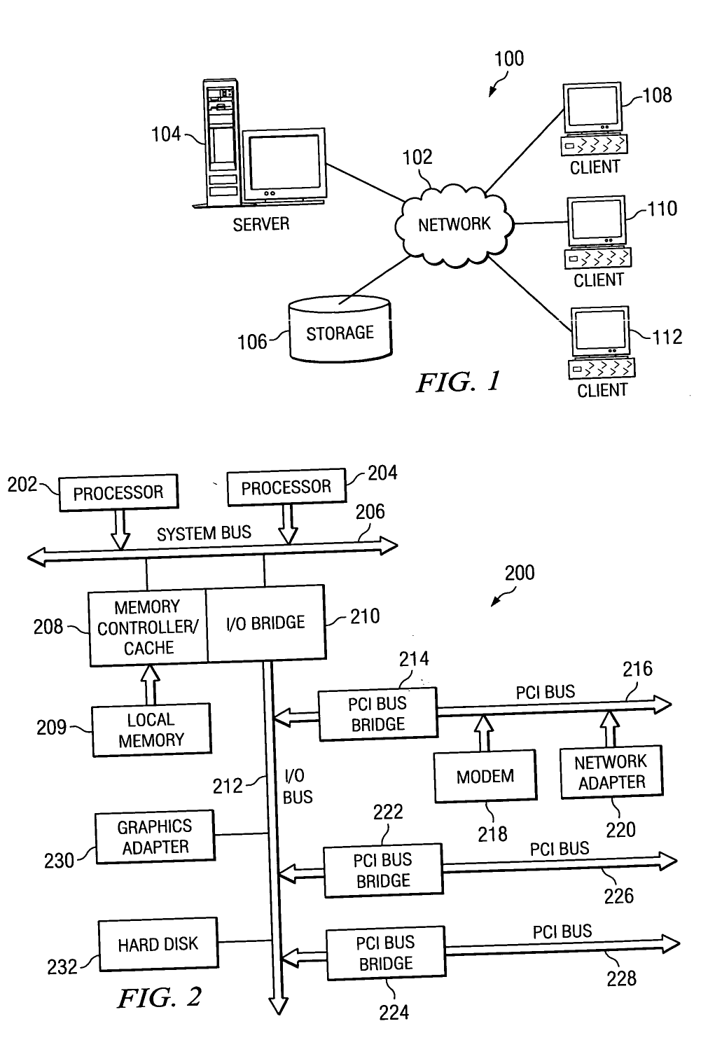

With reference now to the figures, FIG. 1 depicts a pictorial representation of a network of data processing system in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216 A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, New York, running the Advanced Interactive Executive (AIX) operating system or LINUX operating system.

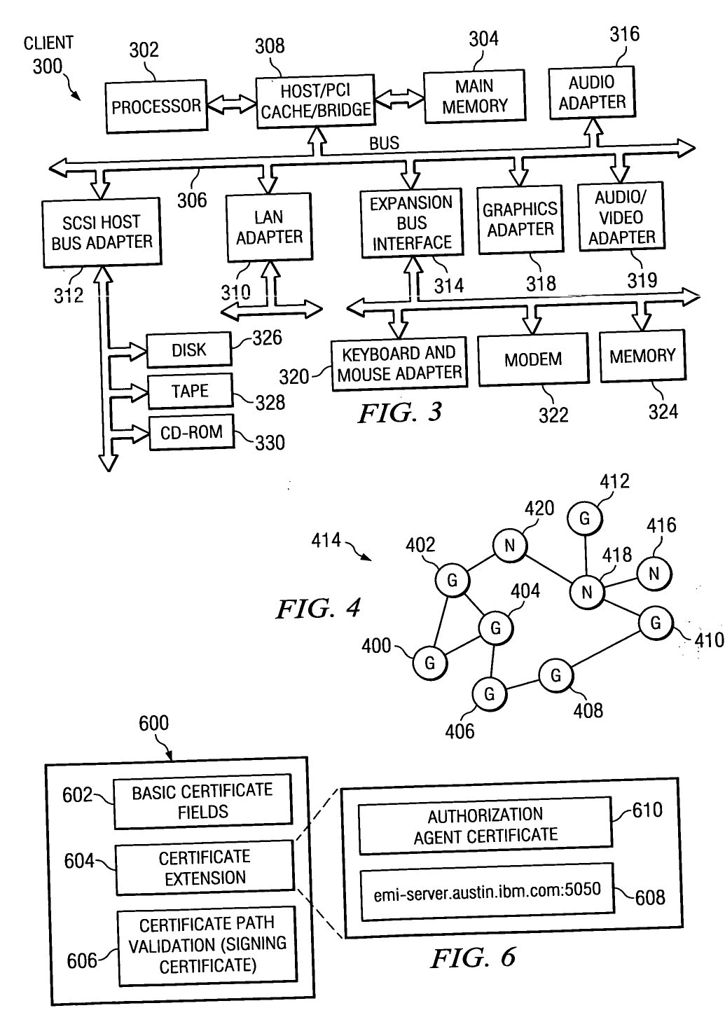

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference now to FIG. 4, a diagram illustrating components used in distributing logical units in a network data processing system is depicted in accordance with a preferred embodiment of the present invention. In this example, nodes, 400, 402, 404, 406, 408, 410, and 412 are nodes in grid 414. Nodes 416, 418, and 420 are nodes that are not part of the grid. These nodes may be located in a network data processing system such as network data processing system 100 in FIG. 1. In this example, these nodes are all nodes that are part of a network such as, the Internet, an intranet, a local area network, a wide area network or some combination of these and other types of networks.

Currently, without the present invention, every node in grid 414 is required to maintain a grid map file that identifies mappings of users to local users. For example, a local intranet name, C=US/O=IBM/CN=smullen@us.ibm.com, is mapped to a local user name, such as “grid user”. Any changes in user privileges, additions or deletions of users, all require each grid map file on each node to be updated.

The present invention provides a method, apparatus, and computer instructions for efficiently managing and identifying local user names in authorizing access to grid resources. The mechanism of the present invention avoids having to use a grid map file that is maintained at every node through the use of an authorizing agent. The authorizing agent maintains the mappings of users to local users in a centralized location. Information, identifying the authorizing agent, is included in the certificate sent requesting access to grid resources. The mechanism of the present invention looks for an identification of the authorizing agent in the certificate, if the certificate authenticates the user. If an authorizing agent is not present, then access to the grid resource is denied even though the user has been authenticated. Such a feature allows for handling situations in which a user may have been removed from a local mapping for a particular grid resource. In this case, no mapping would be present for the user for the particular grid resource. The user may be allowed to use only some resources or may be denied access to all of the resources.

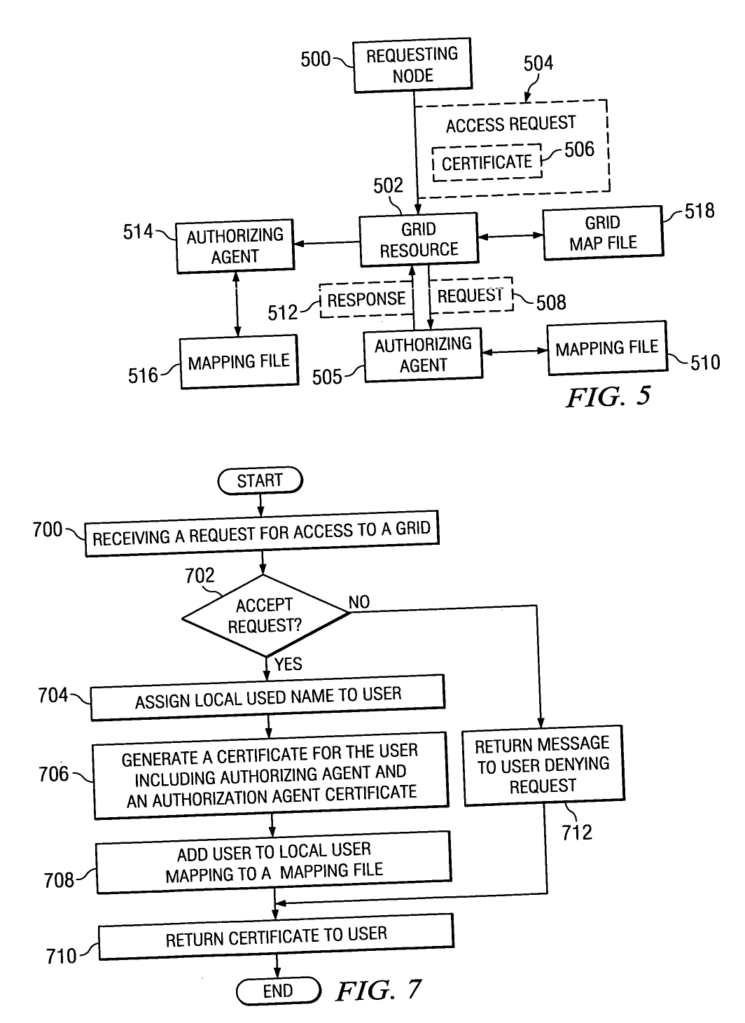

Turning now to FIG. 5, a diagram illustrating components used in authorizing access to grid resources is depicted in accordance with a preferred embodiment of the present invention. In this illustrative example, a user at requesting node 500 may request access to grid resource 502. As described above, a grid resource is a data processing system or a service on a data processing system.

Access request 504 contains certificate 506. In these illustrative examples, certificate 506 is an X.509 certificate currently used in grid systems for authenticating users. The certificate is a public key associated with a digital signature from a certificate authority. The certificate authority signs the certificate by creating a digest, or hash, of all the fields in the certificate and encrypting the hash value with its private key. The signature is placed in the certificate. The certificate may be in turn signed by another certificate authority, forming a chain, which may be followed until the root certificate is found. Certificate 506 is a standard digital certificate format used to authenticate the user as part of the process of the present invention in these illustrative examples.

Grid resource 502 then authenticates the user using certificate 506. Authentication is a process of establishing identity for the purpose of granting access to resources. In these examples, the authentication is performed using an X.509 certificate. The process of verifying the “signed certificate” is performed by decrypting the signature back into the hash value. If the decryption is successful, the identity of the user is verified. The hash is recomputed from the raw data in the certificate and matches it against the decrypted hash. If they match, the integrity of the certificate is verified. For example, certificate 506 may provide the identity C=US/O=IBM/CN=smullen@us.ibm.com.

If the user is authenticated, grid resource 502 then looks for an identification of an authorizing agent, such as authorizing agent 505. If such a identification is not present, access to grid resource 502 is denied. In these illustrative examples, the authentication is performed by the gatekeeper process in the Globus Toolkit. This gatekeeper is part of the Grid Security Infrastructure (GSI) component of this toolkit. Request 508 is sent to authorizing agent 505 in these illustrative examples. This request is used to obtain a mapping of the user as identified in the certificate with a local user name for grid resource 502. This request also may include a certificate that is used to authenticate grid resource 502 with authorizing agent 505. This certificate is provided in certificate 506 along with the identification of the authorizing agent in these illustrative examples.

Authorizing agent 505 looks in mapping file 510 for a local user associated with the identity provided in request 508. In this example, the local user is grid user. This local user name is returned to grid resource 502 in response 512. The local user name is then used to process the request from requesting node 500.

The identification of an authorizing agent is provided in certificate 506, in the instance in which more than one authorizing agent is present to avoid requiring updates at each authorizing agent. For example, authorizing agent 514 may have different users listed in mapping file 516 as compared to mapping file 510. These authorizing agents may be implemented using Enterprise Identity Mapping (EIM), which is an infrastructure available from International Business Machines Corporation. This type of application may be modified to include the mechanisms of present invention for use in mapping users to local users for a grid.

In these illustrative examples, the local user identified by authorizing agent 505 for grid resource 502 provides the access to grid resource 502. The access provided depends on the privileges defined for the particular local user. As a result, different users may be provided different levels of access to grid resource 502 depending on the local user returned to grid resource 502 from authorizing agent 505.

As an additional feature, if the user is authenticated through certificate 506, grid resource 502 may first determine whether a local grid map file, such as grid map file 518 is present. If grid map file 518 is present, then grid resource 502 does not look for an identification of an authorizing agent in certificate 506. If a mapping for the user is present in grid map file 518, then access to grid resource 502 is provided through the local user identified in grid map file 518. Otherwise, grid resource 502 may look for an authorizing agent as described above.

Turning now to FIG. 6, a diagram illustrating a certificate for authorizing a user to access a grid resource is depicted in accordance with a preferred embodiment of the present invention. Certificate 600 may be a certificate, such as certificate 506 in FIG. 5 for use in identifying and authenticating a user to a grid resource. In this illustrative example, certificate 600 is a X.509 v3 certificate. Certificate 600 contains basic certificate fields 602, certificate extension 604, and certificate path validation 606. These fields are part of the ANSI X9 standard, which developed the X509 certificate format, of which version 3 contained extension fields. In a preferred embodiment of the present invention, this field includes a key word to identify the purpose of the extension, such as, “Authorizing Agent” followed by the authorizing agent specific information, such as hostname and port. Thus, the field may look similar to “Authorizing Agent:foo.foobar.com:4000”. In which the authorizing agent machine is foo and the port on this machine looking for authorizing requests is port 4000.

Certificate extension 604 is an extension defined for X.509 v3 certificates. This extension is typically used for associating additional attributes with users or public keys and for managing a certification hierarchy. In the illustrative examples, certificate extension 604 is employed to include authorization agent identification 608 and authorization agent certificate 610. In these illustrative examples, the identification of the authorization agent may be a domain name and a port number that is used to process requests.

Turning next to FIG. 7, a flowchart of a process for generating a certificate for a user is depicted in accordance with a preferred embodiment of the present invention. The process illustrated in FIG. 7 may be implemented in an authorizing agent, such as authorizing agent 505 in FIG. 5.

The process begins by receiving a request for access to a grid (step 700). Next, a determination is made as to whether the request should be accepted (step 702). If the request is to be accepted a local user name is assigned to the user making the request (step 704). Next, a certificate is generated for the user in which the certificate includes an identification of the authorizing agent and an authorization agent certificate (step 706). The user to local user mapping is added to a mapping file (step 708). The certificate is returned to the user (step 710) with the process terminating thereafter.

With reference again to step 702, if the request is not accepted, a message is returned to the user indicating that the request has been denied (step 712) with the process then proceeding to step 710 as described above.

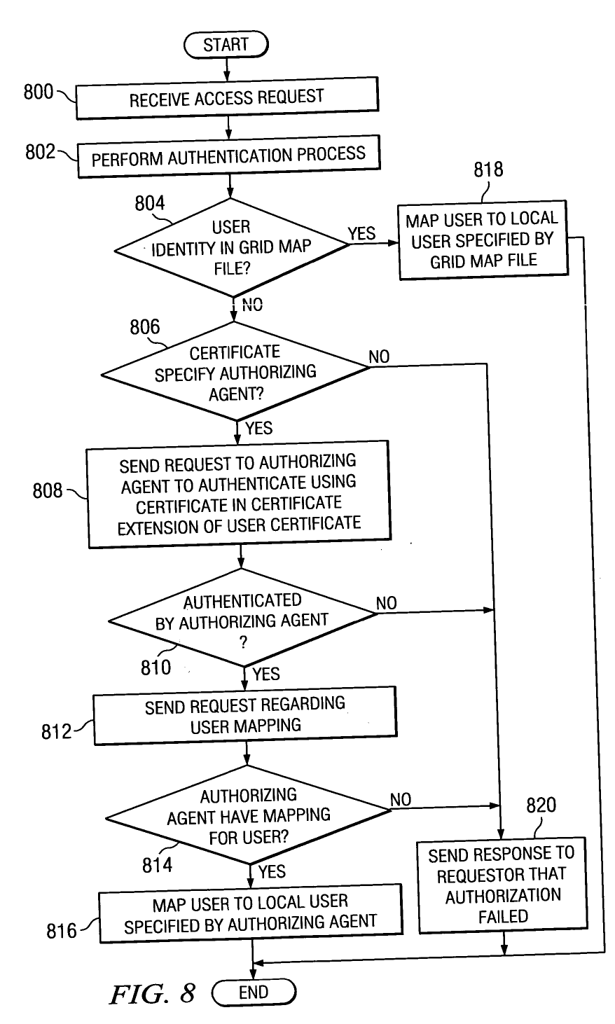

With reference now to FIG. 8, a flowchart of a process for authorizing a user to access a grid resource is depicted in accordance with a preferred embodiment of the present invention. The process illustrated in FIG. 8 may be implemented in a grid resource, such as grid resource 502 in FIG. 5.

The process begins by receiving an access request (step 800). In these examples, the access request includes a request for access to a particular access or service and a certificate identifying the user. Next, an authentication process is performed using the certificate in the access request (step 802). Next, a determination is made as to whether a user identity is in a grid map file (step 804). This grid map file is a optional grid map file, such as grid map file 518 in FIG. 5.

If a user identity is not in a grid map file, then a determination is made as to whether the certificate specifies an authorizing agent (step 806). The certificate may include a domain name and the port number for the authorizing agent. This certificate also may include a second certificate for the authorizing agent. This certificate is also referred to as an authorization agent certificate. This information is found in an extension in the certificate received in the access request.

Next, if a certificate does specify an authorizing agent, then a request is sent to the authorizing agent to authenticate using the authorization agent certificate in the certificate extension of the user certificate (step 808). Next, a determination is made as to whether the request is authenticated by the authorizing agent (step 810). If the request is authenticated by the authorizing agent, then the request is sent regarding user mapping (step 812). Thereafter, a determination is made as to whether the authorizing agent has a mapping for the user identified in the certificate to a local user name for the grid resource (step 814). If the authentication agent does have a mapping for the user, then the user is mapped to a local user specified by the authorizing agent (step 816) with the process terminating thereafter. Depending on the local user assigned to the user, the user may have different privileges in the grid resource. For example, most grid users may have access only to certain services on a node and may be unable to have write privileges on the node. Some users may have access to other services while other users may have a more limited access to a smaller number of services. For example, the mapping may map to a local user called Physics_Student with UID (user ID) 201 and group ID (GID) of 400 (Physics Department group). The local system would then make the directory /school/database/star_research read and writeable to anyone with a GID=400. Alternatively, the executable /usr/bin/move_telescope is only executable by users with the 400 GID.

Referring back to step 804, if a user identity is in a grid map file, then the user is mapped to the local user specified by the grid map file (step 818) with the process terminating thereafter. In step 806, if the certificate does not specify an authorizing agent, then a response is sent to the requester that authorization failed (step 820) with the process terminating thereafter. In step 810, if the request is not authenticated by the authorizing agent the process proceeds to step 820 as described above. In step 814, if the authentication agent does not have mapping for the user, then the process proceeds to step 820 as described above.

Thus, the present invention provides an improved method, apparatus, and computer instructions for authorizing a user to access grid resources. This mechanism involves identifying an authorizing agent to map the identity of the user to a local user for a grid resource. The identification of the authorizing agent is located within a certificate used to authenticate the user. The authorizing agent is queried to identify a local user for the grid resource, rather than requiring the grid resource to consult a local grid map file. By maintaining current user to local user mappings in a centralized location, the mechanism of the present invention avoids the problems associated with having to update mappings at every node in a grid.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the illustrative examples are described with respect to grids, the mechanisms of the present invention may be applied to network data processing systems other than grids.

The embodiment was chosen and described in order to best explain the principles of the invention, the practical application, and to enable others of ordinary skill in the art to understand the invention for various embodiments with various modifications as are suited to the particular use contemplated.

1. A method in a data processing system authorizing a user to access resources on the data processing system, the method comprising:
responsive to receiving a request to access the resources from the user in which the request includes a certificate, performing an authentication process using the certificate;
responsive to the user being authenticated, determining whether an authorizing agent is specified in the certificate;
requesting a mapping for the user from the authorizing agent if the authorizing agent is specified; and
mapping the user to a local user on the data processing system using the mapping in response to receiving the mapping for the user, wherein the user accesses resources on the data processing system as the local user.

2. The method of claim 1 further comprising:
denying access to the user if the authorizing agent is unspecified in the certificate.

3. The method of claim 1, wherein the certificate includes a contact certificate for the authorizing agent and wherein the requesting step comprises:
sending a mapping request to the authorizing agent, wherein the mapping request includes the contact certificate.

4. The method of claim 1, wherein the mapping step includes:
denying access to the user if the mapping for the user returned from the authorizing agent indicates an absence of a mapping for the user for the data processing system.

5. The method of claim 1, wherein the data processing system is a grid resource.

6. The method of claim 1 further comprising:
responsive to the user being authenticated, determining whether the user is present in a mapping file for the data processing system;
responsive to the user being present in the mapping file, skipping the requesting step; and
responsive to the mapping file being present, mapping the user to the local user using the mapping file.

7. The method of claim 1, wherein the certificate is a x509 certificate.

8. The method of claim 7, wherein the authorizing agent is identified in a certificate extension in the x509 certificate.

9. The method of claim 1, wherein the user accesses resources on the data processing system based on privileges defined for the local user.

10. A data processing system authorizing a user to access resources on the data processing system, the data processing system comprising:
performing means, responsive to receiving a request to access the resources from the user in which the request includes a certificate, for performing an authentication process using the certificate;
determining means, responsive to the user being authenticated, for determining whether an authorizing agent is specified in the certificate;
requesting means for requesting a mapping for the user from the authorizing agent if the authorizing agent is specified; and
mapping means for mapping the user to a local user on the data processing system using the mapping in response to receiving the mapping for the user, -wherein the user accesses resources on the data processing system as the local user.

11. The data processing system of claim 10 further comprising:
denying means for denying access to the user if the authorizing agent is unspecified in the certificate.

12. The data processing system of claim 10, wherein the certificate includes a contact certificate for the authorizing agent and wherein the requesting means comprises:
sending means for sending a mapping request to the authorizing agent, wherein the mapping request includes the contact certificate.

13. The data processing system of claim 10, wherein the mapping means includes:
denying means for denying access to the user if the mapping for the user returned from the authorizing agent indicates an absence of a mapping for the user for the data processing system.

14. The data processing system of claim 10, wherein the data processing system is a grid resource.

15. The data processing system of claim 10, wherein the determining means is a first determining means and wherein the mapping means is a first mapping means and further comprising:
second determining means, responsive to the user being authenticated, for determining whether the user is present in a mapping file for the data processing system;
skipping means, responsive to the user being present in the mapping file, for skipping the requesting means; and
second mapping means, responsive to the mapping file being present, for mapping the user to the local user using the mapping file.

16. The data processing system of claim 10, wherein the certificate is a x509 certificate.

17. The data processing system of claim 16, wherein the authorizing agent is identified in a certificate extension in the x509 certificate.

18. The data processing system of claim 10, wherein the user accesses resources on the data processing system based on privileges defined for the local user.

19. A computer program product in a computer readable medium authorizing a user to access resources on the data processing system, the computer program product comprising:
first instructions, responsive to receiving a request to access the resources from the user in which the request includes a certificate, for performing an authentication process using the certificate;
second instructions, responsive to the user being authenticated, for determining whether an authorizing agent is specified in the certificate;
third instructions for requesting a mapping for the user from the authorizing agent if the authorizing agent is specified; and
fourth instructions for mapping the user to a local user on the data processing system using the mapping in response to receiving the mapping for the user, wherein the user accesses resources on the data processing system as the local user.

20. The computer program product of claim 19 further comprising:
fifth instructions for denying access to the user if the authorizing agent is unspecified in the certificate.

21. The computer program product of claim 19, wherein the certificate includes a contact certificate for the authorizing agent and wherein the third instructions comprises:
sub-instructions for sending a mapping request to the authorizing agent, wherein the mapping request includes the contact certificate.

22. The computer program product of claim 19, wherein the fourth instructions includes:
sub-instructions for denying access to the user if the mapping for the user returned from the authorizing agent indicates an absence of a mapping for the user for the data processing system.

23. The computer program product of claim 19, wherein the data processing system is a grid resource.

24. The computer program product of claim 19 further comprising:
fifth instructions, responsive to the user being authenticated, for determining whether the user is present in a mapping file for the data processing system;
sixth instructions, responsive to the user being present in the mapping file, for skipping the third instructions; and
seventh instructions, responsive to the mapping file being present, for mapping the user to the local user using the mapping file.

25. The computer program product of claim 19, wherein the certificate is a x509 certificate.

26. A data processing system comprising:
a bus system;
a memory connected to the bus system, wherein the memory includes a set of instructions; and
a processing unit connected to the bus system, wherein the processing unit executes the set of instructions to perform an authentication process using a certificate, in response to receiving a request to access resources from a user in which the request includes the certificate; determine whether an authorizing agent is specified in the certificate, in response to the user being authenticated; request a mapping for the user from the authorizing agent if the authorizing agent is specified; and map the user to a local user on the data processing system using the mapping in response to receiving the mapping for the user, wherein the user accesses resources on the data processing system as the local user.
